(19) United States
(12) Patent Application Publication
(10) Pub. No.: US 2006/0127664 A1
(43) Pub. Date: Jun. 15, 2006

(54) Tough and durable insulation boards produced in-part with scrap rubber materials and related methods

(76) Inventors: John R. Geary, Carmel, IN (US); Bruce F. Douglas, Zionsville, IN (US); Terence J. O'Connor, Mississauga, CA (US); Greg A. Brandt, Carmel, IN (US); John B. Letts, Carmel, IN (US)

Correspondence Address: Jon D. Wood, Chief I.P. Counsel, Bridgestone Americas Holding, Inc., 1200 Firestone Parkway, Akron, OH, 44317, US

(21) Appl. No.: 11/280,903

(22) Filed: Nov. 16, 2005

Related U.S. Application Data
(63) Continuation-in-part of application No. 10/020,826, filed on Oct. 30, 2001, now abandoned.

(51) Int. Cl. B32B 5/22

(52) U.S. Cl. 428/317.9

(57) ABSTRACT

A composite recovery board (10, 20, 30) comprises a foam core (11) having lower (12) and upper (13) surfaces, wherein the foam core is selected from the group consisting of polyisocyanurate and polyurethane materials and mixtures thereof, and a filler within said foam core selected from the group consisting of rubber-tire vents, EPDM scrap material, plastic chips, polyurethane scrap, polyisocyanurate scrap, scrap rubber from recycled tires, wood chips, fiberglass strands and mixtures thereof. A method of re-roofing a roof comprising applying composite boards (10, 20, 30) of the present invention to a roof deck and applying a weather protective layer over the composite boards. A continuous method of making composite recovery boards (10) of the present invention comprises is also provided.

This application is a continuation-in-part of application Ser. No. 10/020,826, filed Oct. 30, 2001, which is incorporated herein by reference.

### BACKGROUND OF THE INVENTION

This invention relates to a composite board suitable for use as an insulation or recovery board within a roof system. Particularly, the present invention relates to a composite board having improved dimensional stability, especially when exposed to extreme environmental conditions including high heat, humidity and moisture.

Roof construction in a low-pitched roof generally consists of a roof deck, an insulation barrier above the deck, a weather resistant layer applied to the insulation layer, and optionally a layer of heat resistant material. The roof deck generally includes materials such as wood, gypsum, concrete, steel, and the like. Above the roof deck, insulation boards are typically applied to provide thermal insulation and a uniform surface to which the weather protective layer is applied. The most common insulation boards are made of polyisocyanurate, and recovery boards are typically made of woodfiber or extruded polystyrene. Polyisocyanurate may be coated with a protective facer that can be either rigid or flexible and can be fire or flame-retardant. In a re-roofing operation, the roof deck can refer to the existing roof, including the existing insulation and weather resistant layer.

Insulation or recovery boards, as they are referred to in re-roofing, have been employed where the existing roof is leaking. These boards are generally applied to a built-up roof deck to provide a uniform surface when recovering an existing roof. The most common recovery boards are made of woodfiber or extruded polystyrene. Extruded polystyrene typically does not contain a facer.

There are a variety of products that are used as recovery boards including standard polyisocyanurate boards, woodfiber, perlite, Dens-Deck and extruded polystyrene among others. All have limitations, for example, the polyisocyanurate boards is an excellent insulator, but it is not a structural board and can be damaged with excess foot traffic or load and is somewhat moisture sensitive. Woodfiber is relatively durable unless it gets wet and then it degrades quickly into a soggy mess. Perlite is relatively less durable and also turns into a soggy mess in the presence of water and cannot be used with fully adhered single ply roofing systems. Dens-Deck is a good board but is relatively expensive. And extruded polystyrene is sensitive to temperatures that are very close to roof temperatures and is not very durable.

Another key component of any recover board is cost. Ideally, a recover board should be durable to stand up to roof traffic for extended periods of time, be relatively moisture resistant, insensitive to roof top temperatures and be relatively inexpensive. Additionally, any board that is produced has to be manufactured in an inexpensive manner, which usually involves a continuous process. The board will most likely contain a facing material on both of the major sides of the board.

To seal the roof from the elements, the insulation or recovery boards are typically covered with various materials including molten asphalt, modified bitumen membrane, rubberized asphalt, or an elastomeric composition such as EPDM (ethylenepropylene diene monomer). Not all sealing materials mentioned previously are compatible with each type of insulation or recovery board. For example, molten asphalt cannot be used with extruded polystyrene. Correct combinations of sealing material and insulation or recovery boards are known to those skilled in the industry.

Finally, the heat resistant layer of material, which is generally applied directly to the weather resistant layer, can include gravel, river stone, foam or a layer of mastic covered by gravel and the like.

Application of the weather protective layer can be accomplished by a number of means, usually dictated by the type of material employed. For example, sheets of a protective membrane can be rolled out over the roof and bonded together by torching or the use of an adhesive.

The patent literature does include panels and boards used for roofing operations. Built-up roof constructions and the components thereof, for example, are well known in the art.

Thus, a need still exists for an inexpensive recovery board that is tough, durable, moisture resistant and inexpensive.

### SUMMARY OF THE INVENTION

An aspect of the present invention is to provide a relatively inexpensive composite board, particularly for use in re-roofing that is dimensionally stable in hot, humid and wet conditions.

Another aspect of the present invention is to produce a durable, tough and moisture resistant recover board that is relatively inexpensive by utilizing materials such as rubber tire vents that are normally not used and instead are typically discarded.

Generally the present invention provides a composite board comprising a foam core having upper and lower surfaces, wherein said foam core is selected from the group consisting of polyisocyanurate and polyurethane materials and mixtures thereof; and a filler within said foam core selected from the group consisting of rubber-tire vents, EPDM scrap material, plastic chips, polyurethane scrap, polyisocyanurate scrap, scrap rubber from recycled tires, wood chips, fiberglass strands and mixtures thereof.

In another embodiment, the present invention includes a method of re-roofing a roof comprising applying composite recovery boards to a roof deck, the recovery boards comprising a foam core having upper and lower surfaces, wherein the foam core is selected from the group consisting of polyisocyanurate and polyurethane materials and mixtures thereof; and a filler within the foam core selected from the group consisting of rubber-tire vents, EPDM scrap material, plastic chips, polyurethane scrap, polyisocyanurate scrap, scrap rubber from recycled tires, wood chips, fiberglass strands and mixtures thereof; and applying a weather protective layer over the recovery boards.

In still another embodiment, the invention provides a continuous method of making a composite board comprising the steps of feeding a first sheet of facer material into a conveyor assembly; depositing a filled foamable polymer liquid onto the facer; feeding a second facer material into the conveyor assembly above the filled foamable polymer liquid; allowing the filled foamable polymer liquid to rise between the facer materials in order to form filled polymer foam of a predetermined thickness; curing the polymer foam under heat to create the composite board; and cutting the composite board to desired lengths.

Using a filled foam core within the composite board of the present invention makes it dimensionally stable and relatively insensitive to moisture in re-roofing; the present invention thereby meets the existing need for a recovery board that can be exposed to moisture during installation and remain dimensionally stable while wet and during the eventual evaporation of the moisture.

### BRIEF DESCRIPTION OF THE DRAWINGS

FIG. 1 is a perspective view of one embodiment of a composite board in accordance with the present invention;

FIG. 2 is a perspective view of another embodiment of a composite board in accordance with the present invention;

FIG. 3 is a perspective view of a filled foam core in accordance with the present invention; and

FIG. 4 is a schematic view of an apparatus employed to manufacture the composite boards of the present invention.

### DETAILED DESCRIPTION OF ILLUSTRATIVE EMBODIMENTS

The present invention is directed toward a composite board or roofing member that is used to reroof an existing roof. The composite board or roofing member is applied to a roof deck that is substantially flat or low-pitched, and may be newly constructed, or is exposed by the removal of old roofing or, which is an existing built-up roof in suitable condition for recovering. Inasmuch as roof decks are known and do not constitute part of the present invention, other than as a base upon which the roofing members are laid, further detail is not necessary. Although the roofing members can be utilized as part of new roof installations, the boards are specifically designed for reroof operations.

One common problem in most, if not all reroof installations, is a wet and often somewhat deteriorated roof or substrate. Typically, when a leak is noticed, and certainly when it is deemed necessary to repair, use of the board of the present invention provides an inexpensive and facile means of re-roofing either the affected area or more commonly, the entire roof. Thus, the roofing member must have sufficient integrity to patch or cover the roof; it must provide a good base for subsequent application of the final layer or covering, such as an EPDM roofing membrane; and, it must be compatible with the latter and the respective means of application.

In order to provide a recovery board that is tough, durable, moisture resistant and inexpensive, the present invention utilizes inexpensive filler materials incorporated into the foam material comprising the body of the board. Although a variety of materials can be used, scrap materials are preferred because they are inexpensive. The use of inexpensive materials such as rubber tire vents, EPDM scrap material, plastic chips, polyurethane scrap, polyisocyanurate scrap, scrap rubber from recycled tires, wood chips, fiberglass strands, other generally inexpensive materials and mixtures thereof tends to produce a product that is inexpensive. Additionally, these materials can offer durability and toughness to the product. The polyisocyanurate or polyurethane foam acts as a continuous medium to bind these materials together and to bond the combined composite to the facers.

The filler, or discontinuous medium, will be strong, tough and durable and may comprise at least one of the following fillers, rubber tire vents, EPDM scrap material, scrap plastic chips, polyurethane scrap, polyisocyanurate scrap, scrap rubber from recycled tires, wood chips, fiberglass strands, as well as other generally inexpensive materials and mixtures thereof.

In one or more embodiments, the use of tire vents as a filler may be particularly advantageous. Tire vents, which may include small cylindrical pieces of rubber, may offer certain advantages based upon their size and geometry. In certain embodiments, tire vents may be characterized by a length of from about 2 inches to about 1/16^{th} inch, in other embodiments from about 1 inch to about ¼ inch, and in other embodiments from about ½ inch to about ¼ inch. In these or other embodiments, the tire vents may be characterized by an aspect ratio (length/diameter) of from about 64 to about 2, in other embodiments from about 32 to about 8, and in other embodiments from about 16 to about 8. It is believed that the size and geometry of the tire vents may provide for advantageous mechanical and/or physical properties of the construction boards (e.g., recovery boards). It is believed that the size and geometry may also provide advantageous flame retardancy to the construction boards. In fact, the construction boards of one or more embodiments of the present invention can advantageously pass the flame retardancy standards of ASTM E-108 and/or UL-790.

The tire vents may compositionally include cured or crosslinked rubber. The rubber may include cured natural or synthetic rubber. The synthetic rubber may include polydiene rubber such as polybutadiene, polyisoprene, or poly(butadiene-co-isoprene). The rubber may also include copolymers of dienes and styrene including poly(butadiene-co-styrene), poly(isoprene-co-styrene), and poly(butadiene-co-isoprene-co-styrene).

Enhanced flammability resistance can be obtained by adding solid or liquid flame-retardants. In the case of liquid flame-retardants, they will most likely reside in the continuous medium. For aesthetic reasons carbon black or other colors can be added, which in the case of liquid colorants will most likely reside in the continuous medium.

The amount of these components in the discontinuous medium can vary in weight percent relative to the continuous medium from 10 to 1 up to 1 to 100 (continuous to discontinuous). All that is necessary is that the continuous medium is adhered well to the facers and the discontinuous medium(s). Amounts of the filler material (discontinuous) are considerably higher than typically used in polyurethane foam applications. In one or more embodiments, the construction boards (e.g., recovery boards) of the present invention may include from about 90 to about 1, in other embodiment from about 75 to about 5, in other embodiments from about 60 to about 10, and in other embodiments from about 50 to about 15% by weight tire vents based upon the total weight of the foam composition and the tire vents.

With reference to the drawings, composite boards according to the present invention are best described with reference to FIGS. 1-3. The composite board, indicated generally by the numeral 10, comprises a filled foam core 11 having lower and upper surfaces, 12 and 13, respectively. Mating with lower surface 12 of filled foam core 11 is a facer material 14 and mating with upper face 13 is facer material 15. Within filled foam core 11 is filler material 18.

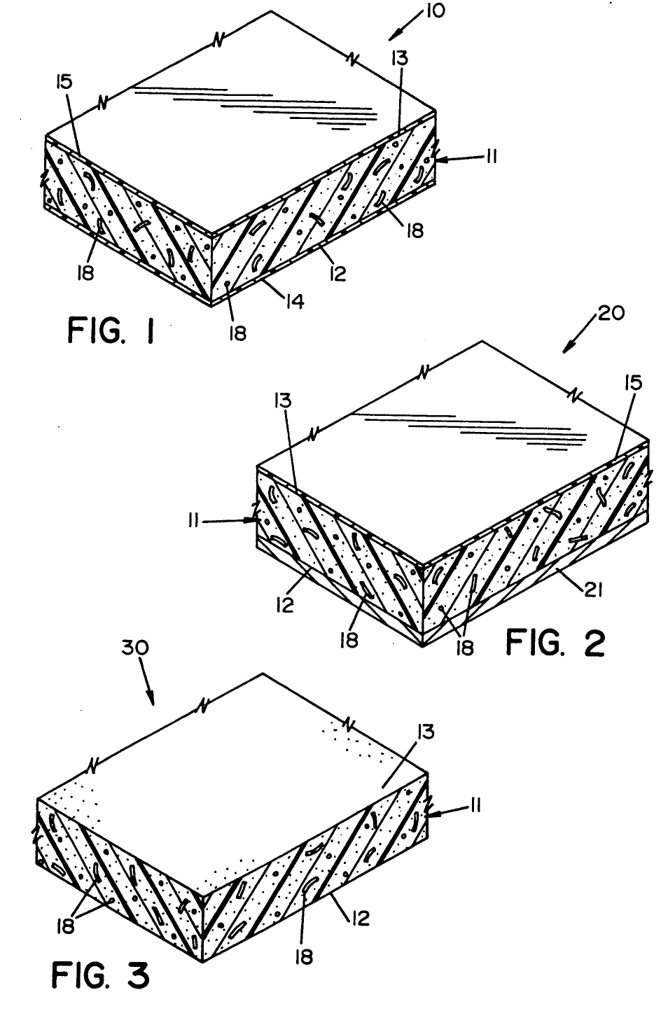

In another embodiment of the present, the composite board according to the present invention is described with reference to FIG. 2. The composite board, indicated generally by the numeral 20, comprises a filled foam core 11 having lower and upper surfaces, 12 and 13, respectively. Mating with lower surface 12 of filled foam core 11 is a substrate material 21, such as gypsum board, and mating with upper face 13 is facer material 15. Within filled foam core 11 is filler material 18. It is also conceivable to manufacture a composite board that comprises a filled foam core 11 having lower and upper surfaces, 12 and 13, respectively, having the substrate material 21, such as gypsum board, mating with lower surface 12 and no facer material mating with upper face 13. Such an embodiment is not depicted separately but would resemble the composite board 20 without the facer material 15.

In another embodiment of the present, the composite board according to the present invention is described with reference to FIG. 3. The composite board, indicated generally by the numeral 30, comprises a filled foam core 11 having lower and upper surfaces, 12 and 13, respectively. Within filled foam core 11 is filler material 18. Unlike the composite boards 10 and 20, the board 30 does not carry any substrate 21 or facer materials 14, 15.

Composite boards 10, 20 and 30 are generally from about 1.2 to about 10.2 centimeters thick, and can be fabricated in various dimensions depending on the intended application. Boards fabricated into sheets 1.2 meters wide and 2.4 meters long are best suited for compatibility in the building trade.

It will be appreciated that the foamed filled cores 11 are identical and thus, reference shall be made generally to the foam core 11 unless otherwise noted. The foam that makes up the filled foam core 11 can be polyisocyanurate, polyurethane, or mixtures thereof. The foam is generally of standard production and generally includes those having an iso index of about 250. Particularly, when polyisocyanurate foam is employed, those having an iso index above 200 are preferred; and when urethane is employed, an iso index above 120 is generally employed. Further, mixed foam can be employed, such as a mixture of polyisocyanurate and polyurethane. Nominal density of the polyisocyanurate and polyurethane foams is about 32 kilograms per cubic meter (kgcm).

In one or more embodiments, the polyisocyanurate foam is characterized by an iso index in excess of 150, in other embodiments in excess of 170, and in other embodiments in excess of 190.

While the construction boards of the present invention may include a facer, the foam structure of the board has a substantially uniform density profile across the entirety of the foam composition. The entirety of the foam composition includes the surfaces, and therefore the boards of one or more embodiments of the present invention are substantially free of a skin. By substantially free of a skin, it is meant that the construction boards do not include a skin surface that will have an appreciable impact on the characteristics of the board. In one or more embodiments, the density of the foam board (excluding any facers) does not vary by more than 25%, in other embodiments by not more than 20%, in other embodiments by not more than 15%, and in other embodiments by not more than 10% across the entirety of the foam composition. In these or other embodiments, the density of the foam together with the tire vents, as determined according to ASTM C303, can be less than 60 pounds per square foot (pcf), in other embodiments less than 50 pcf, in other embodiments less than 40 pcf, and in certain embodiments from about 40 pcf to about 15 pcf. The foregoing density measurements refer to the density of the construction boards absent any compositionally-distinct facer; in other words, the density refers to the foam material and the filler (e.g. tire vents).

The facers may comprise polymer materials, reinforced polymer materials, reinforced cellulosic material, paper, aluminum foil and trilaminates thereof. In particular, the polymer material can include nylon, polyesters, polypropylene, polymer latexes, or mixtures thereof, and the cellulosic material can include recycled paper, cardboard and the like. Examples of polypropylene/polymer latex mixtures include styrene-butadiene rubber (SBR), polyvinyl chloride and polyvinyl alcohol. Thicknesses of the facers typically range between about 0.025 and 0.38 centimeters.

The polymer materials and cellulosic materials for the facers are reinforced with a material selected from the group consisting of glass strands, glass fibers and mixtures thereof. Amounts of such reinforcing materials range from about 100 to about 10,000 parts by weight, based upon 100 parts by weight of the polymer selected to form the facer. More preferably, the reinforcing materials range from about 500 to about 5000 parts by weight, based upon 100 parts by weight of the polymer selected to form the facer. Furthermore, the reinforced polymer material can optionally include fillers such as clay, mica, talc, limestone (calcium carbonate), gypsum (calcium sulfate), aluminum trihydrate, antimony oxide, cellulose fibers, plastic polymer fibers, and mixtures thereof. Amounts of such fillers range from about 0 to about 5000 parts by weight, based upon 100 parts by weight of the polymer selected to form the facer.

In one embodiment, in lieu of a particle board or wood fiber base, the present invention substitutes a layer of gypsum board, which acts as a substrate 21, and which is adhered to the lower surface 12 of the filled foam core 11 (FIG. 2). A suitable substrate/board for this purpose is described in U.S. Pat. No. 5,220,762, the subject matter of which is incorporated herein by reference. Such gypsum boards are manufactured by Georgia-Pacific Corporation and sold under their registered trademark, DENS-DECK. Similar gypsum boards would be equally suitable for practice of the present invention. The advantages include lower cost than wood products and, greater resistance to moisture and wet environments, thereby providing vastly better dimensional stability.

In general, and in a manner that is conventional in the art, the boards of the present invention are preferably produced by developing or forming polyurethane and/or polyisocyanurate foam in the presence of a blowing agent. The foam is preferably prepared by contacting an A-side stream of reagents with a B-side stream of reagents and depositing the mixture or developing foam onto a laminator. As is conventional in the art, the A-side stream includes an isocyanate and the B-side includes an isocyanate-reactive compound.

The A-side stream typically only contains the isocyanate, but, in addition to isocyanate components, the A-side stream may contain flame-retardants, surfactants, blowing agents and other non-isocyanate-reactive components.

Suitable isocyanates are generally known in the art. Useful isocyanates include aromatic polyisocyanates such as diphenyl methane, diisocyanate in the form of its 2,4′-, 2,2′-, and 4,4′-isomers and mixtures thereof, the mixtures of diphenyl methane diisocyanates (MDI) and oligomers thereof known in the art as “crude” or polymeric MDI having an isocyanate functionality of greater than 2, toluene diisocyanate in the form of its 2,4′ and 2,6′-isomers and mixtures thereof, 1,5-naphthalene diisocyanate, and 1,4′ diisocyanatobenzene. Preferred isocyanate components include polymeric Rubinate 1850 (Huntsmen Polyurethanes), polymeric Lupranate M70R (BASF), and polymeric Mondur 489N (Bayer).

The B-side stream, which contains isocyanate reactive compounds, may also include flame retardants, catalysts, emulsifiers/solubilizers, surfactants, blowing agents, fillers, fungicides, anti-static substances, water and other ingredients that are conventional in the art.

The preferred isocyanate-reactive component is a polyol. The terms polyol or polyol component include diols, polyols, and glycols, which may contain water as generally known in the art. Primary and secondary amines are suitable, as are polyether polyols and polyester polyols. Useful polyester polyols include phthalic anhydride based PS-2352 (Stepen), phthalic anhydride based polyol PS-2412 (Stepen), teraphthalic based polyol 3522 (Kosa), and a blended polyol TR 564 (Oxid). Useful polyether polyols include those based on sucrose, glycerin, and toluene diamine. Examples of glycols include diethylene glycol, dipropylene glycol, and ethylene glycol. Of these, a particularly preferred glycol is diethylene glycol. Suitable primary and secondary amines include, without limitation, ethylene diamine, and diethanolamine. The preferred polyol is a polyester polyol, and the present invention is preferably practiced in the appreciable absence of any polyether polyol. Most preferably, the ingredients are devoid of polyether polyols.

Catalysts are believed to initiate the polymerization reaction between the isocyanate and the polyol, as well as a trimerization reaction between free isocyanate groups when polyisocyanurate foam is desired. While some catalysts expedite both reactions, it is common to employ two or more catalysts to achieve both reactions. Useful catalysts include salts of alkali metals and carboxylic acids or phenols, such as, for example potassium octoate; mononuclear or polynuclear Mannich bases of condensable phenols, oxo-compounds, and secondary amines, which are optionally substituted with alkyl groups, aryl groups, or aralkyl groups; tertiary amines, such as pentamethyldiethylene triamine (PMDETA), 2,4,6-tris[(dimethylamino)methyl]phenol, triethyl amine, tributyl amine, N-methyl morpholine, and N-ethyl morpholine; basic nitrogen compounds, such as tetra alkyl ammonium hydroxides, alkali metal hydroxides, alkali metal phenolates, and alkali metal acholates; and organic metal compounds, such as tin(II)-salts of carboxylic acids, tin(IV)-compounds, and organo lead compounds, such as lead naphthenate and lead octoate.

Surfactants, emulsifiers, and/or solubilizers may also be employed in the production of polyurethane and polyisocyanurate foams in order to increase the compatibility of the blowing agents with the isocyanate and polyol components.

Surfactants serve two purposes. First, they help to emulsify/solubilize all the components so that they react completely. Second, they promote cell nucleation and cell stabilization. Typically, the surfactants are silicone co-polymers or organic polymers bonded to a silicone polymer. Although surfactants can serve both functions, a more cost effective method to ensure emulsification/solubilization is to use enough emulsifiers/solubilizers to maintain emulsification/solubilization and a minimal amount of the surfactant to obtain good cell nucleation and cell stabilization. Examples of surfactants include Pelron surfactant 9920, Goldschmidt surfactant B8522, and GE 6912. U.S. Pat. Nos. 5,686,499 and 5,837,742 are incorporated herein by reference to show various useful surfactants.

Suitable emulsifiers/solubilizers include DABCO Kitane 20AS (Air Products), and Tergitol NP-9 (nonylphenol+9 moles ethylene oxide).

Flame Retardants are commonly used in the production of polyurethane and polyisocyanurate foams, especially when the foams contain flammable blowing agents such as pentane isomers. Useful flame retardants include tri(monochloropropyl) phosphate, tri-2-chloroethyl phosphate, phosphonic acid, methyl ester, dimethyl ester, and diethyl ester. U.S. Pat. No. 5,182,309 is incorporated herein by reference to show useful blowing agents.

Useful blowing agents include isopentane, n-pentane, cyclopentane, alkanes, (cyclo)alkanes, hydrofluorocarbons, hydrochlorofluorocarbons, fluorocarbons, fluorinated ethers, alkenes, alkynes, carbon dioxide, and noble gases. Depending on the required density of the board, the amount of blowing agent may need to be decreased. For example, the amount may be reduced to about 2 to about 50%, in other embodiments 4 to about 25%, and in other embodiments 5 to about 10% of that which may be used in a standard formulation. The amount of water may also, optimally, be reduced. The less blowing agent used, the less catalyst is generally used.

In one or more embodiments, the polyols are selected from polyester polyols, and in these or other embodiments, the polyester polyols are aromatic polyols. It is believed that the use of polyester polyols and/or aromatic polyols can advantageously offer desired flame resistance in the face of the inclusion of fillers (e.g., tire vents).

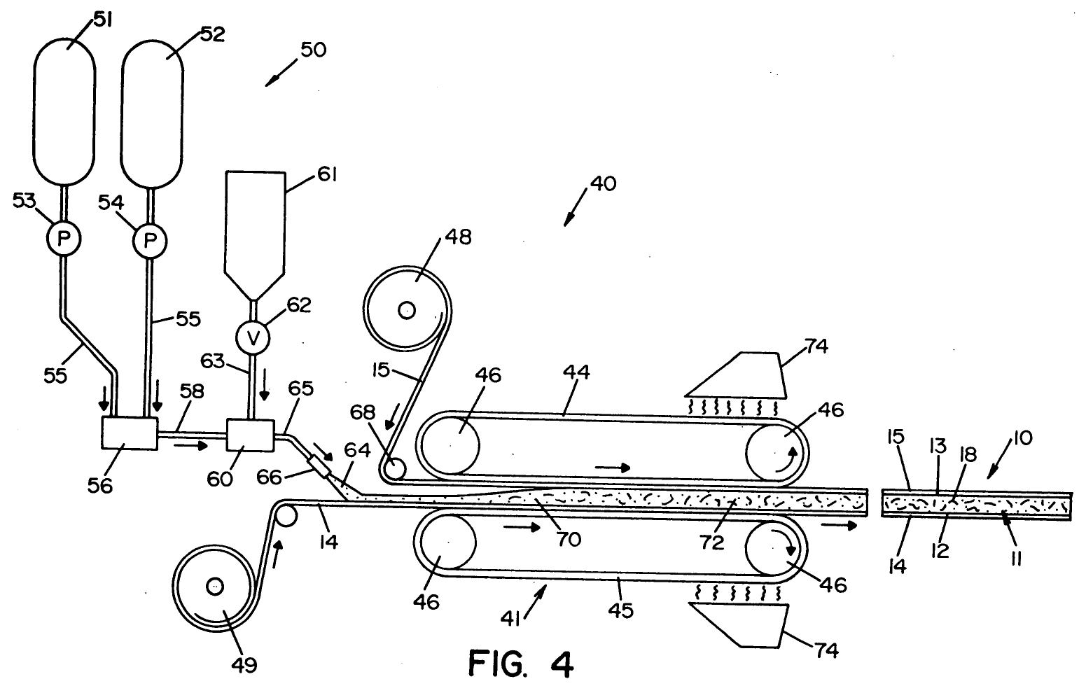

While the composite boards may be manufactured in a batch, continuous, or on-line method, the on-line method is preferred because such a method is both efficient and economical. With reference to FIG. 4, a continuous method for producing embodiments of the present invention is schematically depicted in conjunction with apparatus 40. Apparatus 40 provides conveyor assembly 41 that employs continuous belts or treads, 44 and 45, reeved around a series of rolls 46, several of which are driven. Facer material 15 is carried by an upper spool 48 that is positioned for feeding into conveyor assembly 41. Facer material 14 is carried by a lower spool 49 and is fed into in-feed belt 45.

The process equipment employed to fully disperse the discontinuous medium 11 into the continuous medium 10 prior to laying the material on the bottom facer 14 is included in the polymer feed mechanism of the apparatus, indicated generally by the numeral 50. The polymer feed mechanism includes reservoirs 51 and 52, or whatever number is required by the polymer foam composition selected. Where the desired foam is a polyurethane, for instance, reservoir 51 may provide the isocyanate component and reservoir 52 may provide the polyol component. Resin materials from these reservoirs are fed through metering pumps 53 and 54 and through appropriate conduits 55 into a first chamber 56, where the components are

adjusted in reactivity, not to expand before the discontinuous medium has adequately dispersed into it.

From first chamber 56, the polymer foam travels through conduit 58 into solids mixing chamber 60. Filler material is introduced into solids mixing chamber 60 from feeder 61 and passes through a metering valve 62 and conduit 63 into the chamber 60.

In one or more embodiments, particularly where the tire vents are employed as the filler material, the filler material is heated prior to introducing the filler material into the solids mixing chamber and contacting the same with the polymer foam. In one or more embodiments, the filler material is heated to a temperature of about 200° F. to about 90° F., in other embodiments from about 175° F. to about 110° F., and in other embodiments from about 150° F. to about 120° F.

When both the foam components and the filler material have entered solids mixing chamber 60, they are agitated until a homogenous mixture is obtained. This homogenous filled foamable composition 64 then travels via conduit 65 to dispensing nozzle 66. Enough energy is expanded for the continuous medium to cover approximately 90% of the discontinuous medium with at least a thin layer.

Dispensing nozzle 66 then delivers an appropriately metered amount of filled foamable composition 64, onto the surface of moving facer 14. Subsequently, and slightly downstream of dispensing nozzle 66, facer material 15 is fed into the drive assembly 41, passing around a feed roller 68, which positions facer 15 against upper belt 44. As facers 14 and 15, and deposited filled foamable composition 64 are conveyed, the latter rises, as depicted at 70, until facer 15 is in complete contact with upper belt 44. It is to be appreciated that belts 44 and 45 are adjustable to accommodate the desired thicknesses of board 10.

In one or more embodiments, the filler (e.g., tire vents) can be added to the mixture of the A-side and B-side reactants after the A-side and B-side reactants have been combined. The combination of the A-side, B-side, and filler can be further mixed. For example, mixing can occur by way of a propeller mixer, a dynamic baffle and/or an auger, which mixing apparatus may be positioned in line. In one example, multiple mixing apparatus are used such as the use of a propeller mixer or dynamic baffle followed by an auger. For example, mixing can occur by way of a propeller mix Following this mixing, the mixture can then be laid down on the laminator, which may carry a facer sheet.

In order to facilitate mixing of the A-side, B-side, and filler, it may be advantageous to delay rise of the foam. For example, it may be advantageous to delay rise such that the volume of the foam mixture will not increase by more than 10% in the first 10 seconds, in other embodiments in the first 5 seconds, and in other embodiments in the first 3 seconds from the time that the A-side and B-side reactants are contacted.

In one or more embodiments, this delay may be effected by the type and amount of catalyst employed. For example, delayed action catalysts may be substantially or exclusively employed. The substantial use of delayed action catalysts refers to the sue of less non-delayed action catalysts than would otherwise have an appreciable impact on the rise time of the foam. In one or more embodiments, the process is devoid of any non-delayed action catalysts. Useful delayed-action catalysts include useful delayed-action catalysts include amine catalysts such as quaternary amine catalysts. The ligand associated with the quaternary amine catalyst may vary. In one or more embodiments the ligand includes a carboxylic acid such as formic acid, 2-ethylhexanoic acid, naphthenic acid and mixtures thereof. Delayed-action catalysts are commercially available under the trade names Pelcat 9715, Pelcat 9716, Pelcat 9751, Pelcat 9529, DABCO BC-17, DABCO DC-1, DABCO H-1010, DABCO TMR-3, DABCO 8154, and Polycat SA1/10. In one or more embodiments, the total amount of catalyst employed may also be limited. For example, less than 6.0 pphp, in other embodiments less than 4.0 pphp, and in other embodiments less than 3.0 pphp delayed action catalysts are employed.

The type and amount of blowing agent and/or water may also be controlled to impact the ability to incorporate filler into the foam. For example, blends of isopentane and n-pentane from 3 to 20 pphp and water from 0.1 to 2.0 pphp. Additionally, nitrogen and/or air can be added at above 1-5 liters per minute.

After the foaming has completed, intermediate product 72, is heated to effect curing of filled foamable composition 64. This is accomplished by appropriately located heaters 74, or by passage through an oven (not shown). After heating for the appropriate time (residence) and temperature, the product emerges from the conveyor and is cut to length to produce composite boards 10. Such cutting is within the skill of the art, including flying cut-off saws and the like, which provide desired dimensions without interruption of apparatus 40. While lengths can be varied at will on such apparatus, the widths of the composite boards 10 can subsequently be trimmed to size in a separate operation, as necessary. It is also possible to provide sidewalls (not shown) in conjunction with drive assembly 41, to define the desired widths as the polymer is foaming within the conveyor.

A laboratory prototype of this invention with rubber tire vents dispersed in the foam gave a strong product (three times the compressive strength of a standard polyisocyanurate board i.e., 70 psi). Addition of rubber tire vents was found to improve toughness and durability. Because roof traffic on commercial roofs especially new construction can lead to facer delamination and crushed foam, the product of this invention will minimize the effect of such roof traffic. Rubber incorporation into the foam enhances water resistance. Finally, although gypsum altered products, such as Dens-Deck, utilized in conjunction with the board 20, will perform very well as a recover board, they do increase the cost. The preferred product of this invention, composite board 10, will be approximately 40% less expensive than the board 20; however, due to the addition of inexpensive filler material 18 into its foam core 21, that product will also benefit from increases in strength and water resistance.

Although the method has been described in conjunction with the manufacture of composite board 10, it is to be appreciated that the board 20 can be similarly fabricated with substitution of a substrate material, such as DENS DECK or particle board, for the lower facer 14. Similarly, it is to be appreciated that the board 30 can be similarly fabricated by the use of temporary facers materials in lieu of facers 14 and 15, which facers can subsequently be removed to provide a facer less board 30.

Use of the board in re-roofing is practiced in the same manner as the installation of known recovery boards and basically involves the steps of applying composite recovery boards to a roof deck, and applying a weather protective layer over the recovery boards.

Thus, it should be evident that the composite boards and methods of the present invention are highly effective in providing composite boards useful for re-roofing. The invention is particularly suited for re-roofing, but is not necessarily limited thereto. The method of the present invention for manufacturing varying embodiments of the present inventions composite boards, can be practiced with other equipment and, the method for re-roofing can be practiced with the variety of boards 10, 20 and 30 that fall within the scope of the present invention.

Based upon the foregoing disclosure, it should not be apparent that the use of composite boards with filled foam cores described herein will provide the benefits set forth herein. It is, therefore, to be understood that any variations evident fall within the scope of the claimed invention and thus, the selection of specific component polymers, fillers, facer materials and the like can be determined without departing from the spirit of the invention herein disclosed and described. In particular, composite boards according to the present invention are not necessarily limited to those having a filled polyisocyanurate or polyurethane foam core. Moreover, as noted hereinabove, the independent composition(s) of the polymer facer(s) can be varied, particularly with the use of optional fillers. Thus, the scope of the invention shall include all modifications and variations that may fall within the scope of the attached claims.

What is claimed is:

1. A filled-polyisocyanurate board comprising:
a foam matrix including polyisocyanurate and characterized by an iso index about 200; and
tire vents dispersed throughout said matrix.

2. The board of claim 1, where said tire vents are characterized by a length from about 2 inches to about 1/16^{th} inch.

3. The board of claim 2, where said tire vents are characterized by a length from about 1 inch to about ¼ inch.

4. The board of claim 3, where said tire vents are characterized by an aspect ration of from 64 to about 2.

5. The board of claim 4, where said tire vents are characterized by an aspect ration of from 32 to about 8.

6. The board of claim 1, where the board passes the flame retardancy standard of ASTM E-108.

7. The board of claim 1, where said tire vents include cured natural or synthetic rubber.

8. The board of claim 7, where synthetic rubber includes polybutadiene, polyisoprene, or poly(butadiene-co-isoprene), poly(butadiene-co-styrene), poly(isoprene-co-styrene), and poly(butadiene-co-isoprene-co-styrene).

9. The board of claim 1, where the boards include from about 90 to about 1 percent by weight tire vents based on the total weight of said foam and said vents.

10. The board of claim 9, where the boards include from about 75 to about 5 percent by weight tire vents based on the total weight of said foam and said vents.

11. The board of claim 1, where said foam has a substantially uniform density profile across the entirety of the foam.

12. The board of claim 1, where said foam is substantially free of a skin.

13. The board of claim 1, where said foam has a density that does not vary by more than 25% across the entirety of the foam.

14. The board of claim 13, where said foam has a density that does not vary by more than 10% across the entirety of the foam.

15. The board of claim 1, where said foam has a density, according to ASTM C303, of less than 60 pcf.

16. The board of claim 15, where said foam has a density, according to ASTM C303, of less than 40 pcf.

17. The board of claim 1, where said foam is characterized by an iso index in excess if 150.

18. The board of claim 1, where said foam is prepared from a polyester polyol.

19. The board of claim 18, where said foam is prepared from polyols that are devoid of polyether polyols, and where the polyester polyol is an aromatic polyester polyol.

20. A method for producing a filled construction board, the method comprising:
contacting an A-side and a B-side stream of reactants, where the A-side includes an isocyanate-containing compound, and the B-side includes an isocyanate-reactive compound and a delayed-action catalyst, to form a reactive mixture;
adding tire vents to said reactive mixture, where the tire vents are heated to a temperature of from about 90° F. to about 200° F.,
mixing the reactive mixture containing the tire vents; and
depositing the mixture.
